(19) United States
(12) Patent Application Publication
(10) Pub. No.: US 2005/0229171 A1
(43) Pub. Date: Oct. 13, 2005

(54) Distributing upgrades

(76) Inventors: Steven G. Henry, Fort Collins, CO (US); Chris Richard Gunning, Boise, ID (US); Clint Stephen Cuzzo, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/895,721

(22) Filed: Jul. 21, 2004

Related U.S. Application Data
(60) Provisional application No. 60/560,079, filed on Apr. 7, 2004.

(51) Int. Cl. G06F 9/44

(52) U.S. Cl. 717/168

(57) ABSTRACT

A system includes a transmitter for receiving a software upgrade and transmitting a message that includes the software upgrade and a digital signature. A receiver receives the message, and authenticates the digital signature. In response to authentication of the digital signature, the receiver installs the software upgrade associated with the message transmitted by the transmitter.

### RELATED APPLICATIONS

This application claims the benefit under 35 U.S.C. 119(e) of U.S. Provisional Application Ser. No.60/560,079 filed Apr. 7, 2004.

### BACKGROUND

Computing devices, such as imaging systems, printers, fax machines, digital senders, multi-function peripherals, copiers, digital network copiers are virtually omnipresent today. Computing devices can be found in homes and offices worldwide. Many of the computing devices include hardware that executes a set of computer-readable instructions known as firmware. The software tailored to specific hardware is generally known as firmware. Firmware gets its name from having characteristics of both hardware and software. Firmware is typically provided as software or a set of computer-readable instructions embedded within read-only memory (“ROM”), compact flash memory, or on a disk drive. A ROM includes a Programmable ROM (“PROM”) and an Erasable Programmable ROM (“EPROM”). Generally, firmware includes startup routines and low-level input/output instructions for a particular set of hardware. Development of new features is generally ongoing throughout the product life cycle of many computing devices. Firmware upgrades are generally the vehicle to provide users with more features as well as to fix any bugs that may have been associated with earlier versions of a computing device. At present, firmware upgrades are used to distribute new capabilities to hardware as the new capabilities become available.

Networks of computing devices are also prevalent in homes and offices worldwide. Networks allow various devices to be connected to one another for the purposes of file sharing and resource sharing. Home networks are generally small. Networks associated with businesses are generally larger. There are also very large networks associated with businesses as well as the public network, known as the Internet. Networks take the form of the Internet as well as local area networks (LANs) and wide area networks (WANs). As networks become larger, they also seem to become increasingly complex. The Internet is complex in that many forms of computing devices are attached to the network. Many computing devices attached to a network execute on instructions copied to the computing device or on software specifically tailored to the hardware of the computing device. As mentioned above, the software tailored to the specific hardware is generally known as firmware. Firmware is upgraded by changing the software or set of computer-readable instructions embedded on the ROM, the compact flash memory, or on the disk drive. Firmware is generally more easily upgraded and less costly to upgrade than upgrading hardware for a device.

In sizable networks, such as LANs, WANs and the Internet, distributing upgrades to a selected subset of network devices attached to a LAN or WAN or the Internet is also becoming a more complex task. Generally, sizable networks with a variety of computer devices attached to the network have one or more systems administrators that upgrade the various network devices and keep the network in working order. Upgrades can be made by network administrators by sitting at individual computing devices and downloading a shared file on the network to the hardware being upgraded.

Upgrades are also generally made available for various computer devices attached to network using an automatic upgrade service. Many network-connected computing devices available today offer the automatic upgrade service where periodically, the network-connected computing device, such as a personal computer, will go to a web service and either upgrade automatically or provide the user with the ability to approve or reject an upgrade. This approach is effective when individual users are in charge of upgrading their network devices. This approach is less effective if a system administrator manages a sizable network. This approach is inefficient if a system administrator wants to upgrade a number of network computer devices that are the same on a large network. If the system administrator relies on users to implement a firmware upgrade from a remote source, the results generally are disastrous since different versions of the firmware upgrade or no upgrade at all will be loaded on different computing device of the same kind across a network.

Use of an automatic upgrade service where periodically, the network-connected computing device, such as a personal computer, will go to a web service and either upgrade automatically or provide the user with the ability to approve or reject an upgrade may present security issues on the network. If firmware updates are not added in a secure environment, it is possible that the device security for the various devices could be compromised. For example, an update could include code that allowed sending confidential information outside the organization without any warning.

### BRIEF DESCRIPTION OF THE DRAWINGS

FIG. 1 is a schematic diagram of a set of a transmitter communicatively coupled to a receiver, according to an embodiment of this invention.

FIG. 2 is a schematic diagram of a transmitter communicatively coupled to a set of receivers by way of a network, according to an embodiment of this invention.

FIG. 3 shows a flow diagram of a method for distributing a software upgrade according to an embodiment of this invention.

FIG. 4 is a flow diagram of a method for distributing a software upgrade according to an embodiment of this invention FIG. 5 is a screen shot of a user interface on the transmitter for receiving input from a user of the administrator transmitter as to the destination of a software upgrade among a set of receiver devices according to an embodiment of this invention.

FIG. 6 is a flow diagram of a method for receiving a software upgrade according to an embodiment of this invention.

FIG. 7 is a schematic diagram of a computing device, according to an embodiment of this invention.

FIG. 8 is a block diagram of a computer readable medium that includes an instruction set thereon, according to an embodiment of this invention.

FIG. 9 is a schematic of a data structure associated with a message according to an embodiment of the invention.

FIG. 10 is a flow diagram of a method for receiving a software upgrade according to an embodiment of this invention.

### DETAILED DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

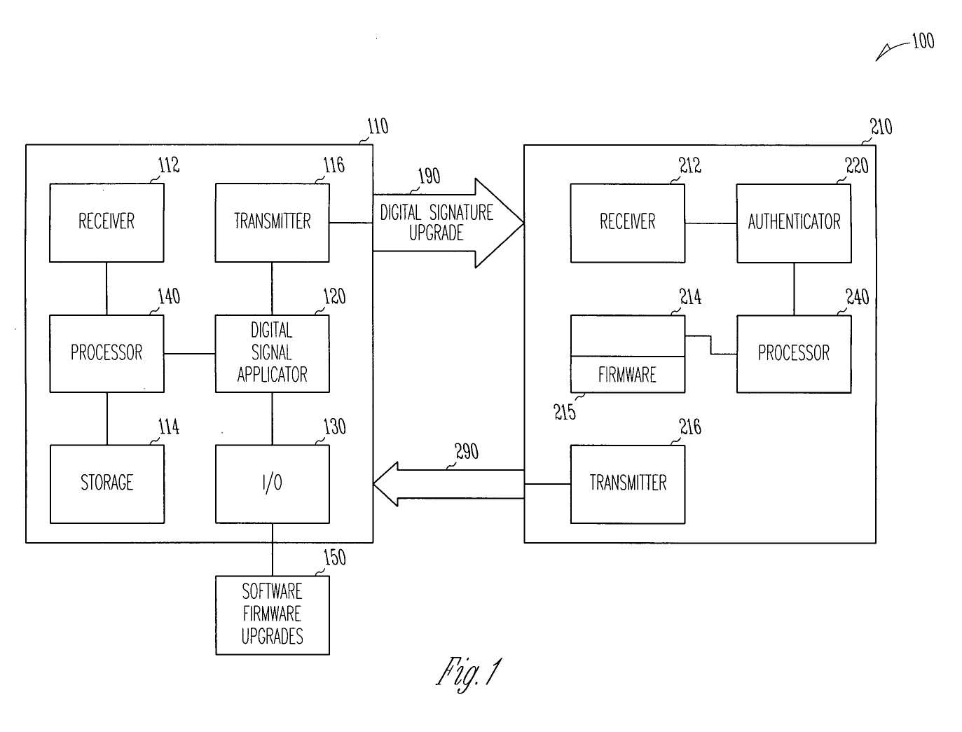

FIG. 1 is a schematic diagram of a system 100 for distributing a software upgrade, such as a firmware upgrade, from a sender or a transmitter 110 to a receiver of the software upgrade 210. As shown in FIG. 1, the transmitter 110 is communicatively coupled to the receiver 210, according to an embodiment of this invention. As used herein, software is a set of computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired. The term firmware is used to denote software tailored to specific hardware. Firmware gets its name from having characteristics of both hardware and software. Firmware is typically provided as software or a set of computer-executable instructions embedded within read-only memory (“ROM”), compact flash memory, or a disk drive. ROM includes a Programmable ROM (“PROM”) and an Erasable Programmable ROM (“EPROM”).

As mentioned previously, FIG. 1 shows the sender or transmitter 110 communicatively coupled to the receiver 210, according to an embodiment of this invention. The sender or transmitter 110 includes a receiver 112, a storage device 114, a message transmitter 116, a digital signature applicator 120, an input/output device 130 and a processor 140. The transmitter/sender 110 also includes a source of a software or firmware upgrades 150. The receiver 210 includes a receiver 212, a storage device 214, a message transmitter 216, a digital signature authenticator 220, and a processor 240. As shown, the receiver also includes a firmware storage device 215. The firmware storage device 215 includes a ROM device, such as a PROM or EPROM, compact flash memory, or a disk drive. In many instances the firmware storage device is physically separated from the other storage device 214. As shown in FIG. 1, the firmware storage device 215 is associated with the storage device 214. As shown in FIG. 1, the sender or transmitter 110 sends a message 190 including upgrade and a digital signature 190 to the receiver 210. The receiver authenticates the digital signature and sends an acknowledgement 290 to the sender or transmitter of the message 190.

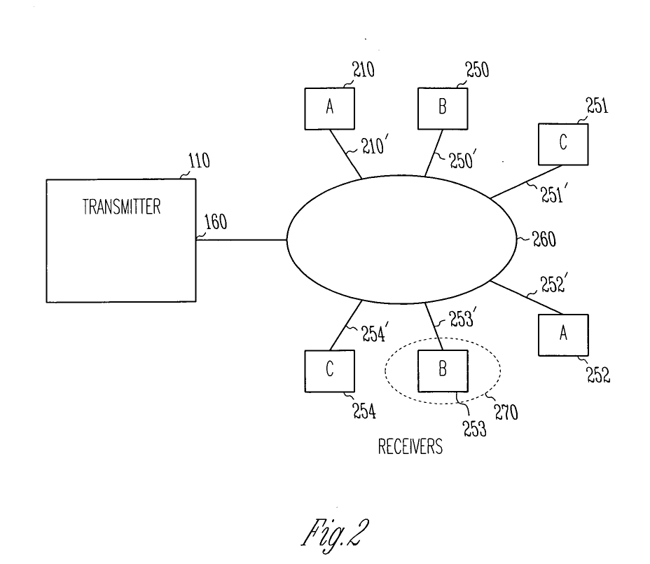

FIG. 1 shows a single transmitter 110 communicatively coupled to a single receiver 210. FIG. 2 is a schematic diagram of a transmitter communicatively coupled to a set of receivers 210, 250, 251, 252, 253, and 254 by way of a network 260, according to an embodiment of this invention. The network 260 can be any type of network including a Local Area Network (LAN), a wide area network (WAN) or the Internet, or a similar network. Each of the receivers 210, 250, 251, 252, 253, 254 includes a configuration similar to the configuration receiver 210 (see FIG. 1). It should be noted, however, that some of the receivers 210, 250, 251, 252, 253, 254 will not have a separate storage device for firmware. The receivers 210, 250, 251, 252, 253, 254 that do not have separate storage devices for firmware generally include storage devices 214 for receiving and storing software upgrades. The sender or transmitter 110 shown in FIG. 2 includes a source of software firmware upgrades. One source of the upgrades, as shown in FIG. 2, is the network 260. The transmitter 110 includes an interface and a connection to the network 160. Each of the receivers 210, 250, 251, 252, 253, 254 also includes an interface and connection to the network 210′, 250′, 251′, 252′, 253′, and 254′, repectively. Receiver 253 is provided with a firewall 270. The firewall 270 includes a set of related programs, implementable in both hardware and software, located at a network connection that protects the resources of a private network from users from other networks. The firewall is a security device.

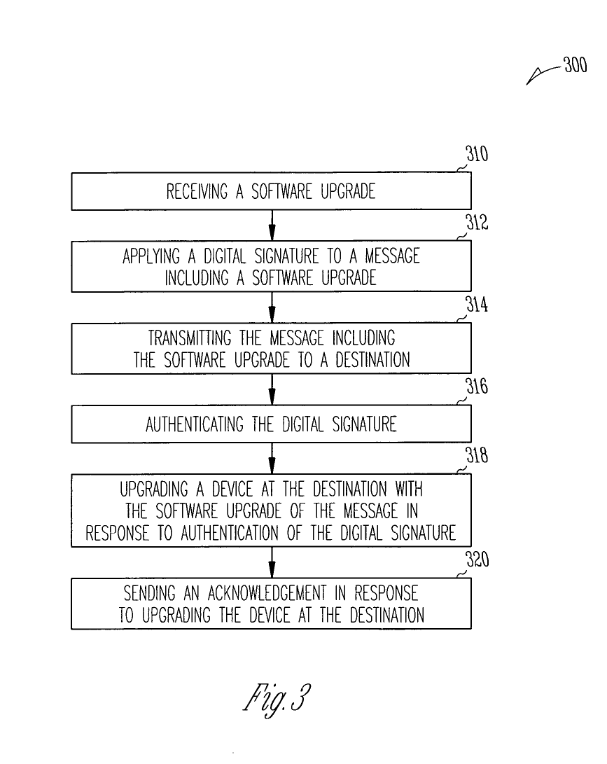

FIG. 3 is a flow diagram of a method for distributing a software upgrade 300, according to an embodiment of this invention. The method 300 includes receiving a software upgrade 310, and applying a digital signature to a message including the software upgrade 312, and transmitting the message including the software upgrade to a destination 314. As shown in FIGS. 1 and 2, the destination is one or more of the receivers 210, 250, 251, 252, 253, 254. The method 300 further includes authenticating the digital signature at the destination 316. The method 300 also includes upgrading a device at the destination with the software upgrade of the message in response to authentication of the digital signature 318. In one embodiment of the invention, applying a digital signature to the message 312 includes identifying the transmitter of the message with the digital signature. For example, when the transmitter 110 is a network administrator's computer, the digital signature applicator 120 applies a digital signature, associated with the network administrator's computer or transmitter 110, to a message that contains the software upgrade. It should be noted that a software upgrade, as discussed herein, also includes a firmware upgrade for upgrading hardware. At the receiver, such as one of the receivers 210, 250, 251, 252, 253, 254, the digital signature is authenticated as being from the network administrator's computer or transmitter 110. In this way, the receiver 210, 250, 251, 252, 253, 254 assures that the software upgrade is from the appropriate transmitter, such as the network administrator's computer. Once authenticated, the software upgrade is applied. This adds a level of security to the upgrade process as it prevents software upgrades from sources other than a selected source or transmitter 110.

In another embodiment, applying a digital signature to the message 312 includes identifying the transmitter of the message with the digital signature, and identifying the destination (receiver) of the message with the digital signature. The digital signature can include information specific to the receiver 210, such as the machine address code (“MAC”), the serial number of the receiver 210 or some other unique identifier. This is also an added security feature in that the receiver 210, by authenticating the digital signature, is able to determine that the network administrator's computer (transmitter 110) sent the software upgrade and also specifically directed it to the selected receiver 210, 250, 251, 252, 253, 254. In the embodiment, the receiver 210, 250, 251, 252, 253, 254 verifies a match with the unique identifier before applying or installing the software upgrade. Some embodiments of the method 300, include sending an acknowledgment in response to upgrading the device at the destination (receiver) 320. In some embodiments of the invention, the model number of the receiver can be the identifier or the model number and the version number of software. This would allow a blanket sending of the upgrade to all receivers on a network 260 with only the receivers having the selected model number or model number and software version number upgrading in response to receiving the message. In some embodiments, the message can be an E-mail.

In another embodiment of the invention, the digital signature is accompanied by a time stamp. The receiver upon receiving the message, applies the software upgrade only when the difference between the time stamp and the actual time is less than a selected amount of time. This prevents application of an old “upgrade” which could be a downgrade. This prevents a user from copying the upgrade message and resending it at a much later date. In another embodiment, the version level is checked so that an unintentional downgrade is not applied.

Adding time and date information and version information is an additional security and protection feature. The time and date information is used by each selected receiver to prevent accidental or deliberate unauthorized “downgrades” of the firmware to an earlier version. It is conceivable that a downgrade could occur if an old “upgrade” email message was accidentally put out on the network by an overall system recovery operation. It is also possible that an old email upgrade message could be saved and then at a future date accidentally or even maliciously applied. A variety of different policies could be applied to limit the period of time that an upgrade would be accepted and applied by each selected receiver. For example, the devices could have a policy that no firmware upgrade containing a digital signature with a timestamp older than 1 month than the current time and date would be accepted without direct user intervention at the front panel of each selected receiver. Similar checking and policies can be established at each selected receiver regarding whether or not to accept firmware upgrades with a revision earlier than the existing upgrade.

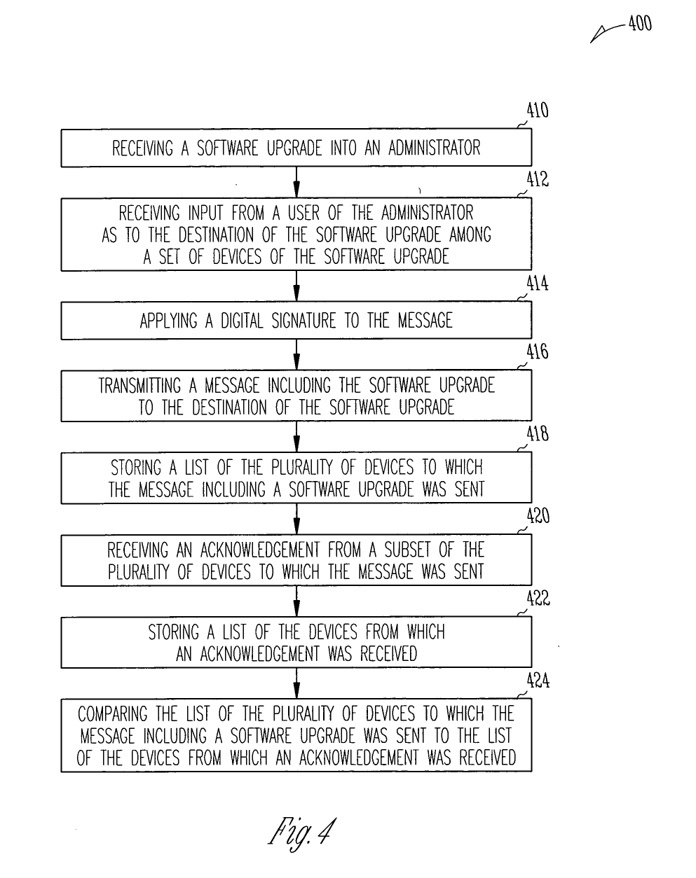

FIG. 4 is a flow diagram of a method for distributing a software upgrade 400, according to an embodiment of this invention. The method for distributing software 400 discusses other aspects of distributing software from an administrator computer (transmitter 110 shown in FIGS. 1 and 2). The method for distributing a software upgrade 400 includes receiving a software upgrade into an administrator 410, and receiving input from a user of the administrator as to the destination of the software upgrade among a set of devices (receivers 210, 250, 251, 252, 253, 254 of FIGS. 1 and 2) of the software upgrade 412. The method 400 also includes applying a digital signature to the message 414, and transmitting a message including the software upgrade to the destination of the software upgrade 416. Applying a digital signature to the message 414 includes identifying the administrator with at least a portion of the digital signature, or applying a digital signature identifying the administrator and identifying the destination of the software upgrade with at least a portion of the digital signature. Identifying the destination receivers (receivers 210, 250, 251, 252, 253, 254 of FIGS. 1 and 2) of the software upgrade includes identifying a plurality of devices to be upgraded. The method 400 also includes storing a list of the plurality of devices to which the message including a software upgrade was sent 418. An acknowledgement is received from a subset of the plurality of devices to which the message was sent 420; and a list of the devices from which an acknowledgement was received is stored 422. The stored list of devices acknowledging receipt of a software upgrade is compared to the list of the plurality of devices to which the message including a software upgrade was sent 424. In this way the administrator can determine which of the receivers (receivers 210, 250, 251, 252, 253, 254 (shown in FIGS. 1 and 2) received the software upgrade. In another embodiment of this invention, the acknowledgment messages are sent after the software upgrade has been successfully applied or stored at the destination or receivers 210, 250, 251, 252, 253, 254 (shown in FIGS. 1 and 2). This allows the administrator, such as transmitter 110 (shown in FIGS. 1 and 2), to track the progress of software upgrades and determine where upgrades have not been successfully applied.

FIG. 5 is a screen shot of a user interface 500 on the administrator transmitter 110 for receiving input from a user of the administrator transmitter as to the destination of the software upgrade among a set of devices, such as receivers 210, 250, 251, 252, 253, 254 (shown in FIGS. 1 and 2) according to an embodiment of this invention. The interface 500 includes a browser 510 and a distribution list of receivers that need a first upgrade 520 and a distribution list of receivers that need a second upgrade 530. An administrator of a network has a series of distribution lists 520, 530 that include E-mail addresses of all the receivers 210, 250, 251, 252, 253, 254 (shown in FIGS. 1 and 2). Each of the distribution lists 520, 530 include a subset of receivers that require or need a selected upgrade. As shown in FIG. 2, the receivers 210 and 252 include a letter “A” that indicates these two receivers are the same type of electronic device. Similarly, the receivers 250 and 253 include a letter “B” that indicates these two receivers are the same type of electronic device, and the receivers 251 and 254 include a letter “C” that indicates these two receivers are the same type of electronic device. Same type can mean exactly the same make and model, in some embodiments. In other embodiments, the same type can mean meeting the same standard or being within the same class of electronic device. An administrator can keep a variety of different distribution lists for different classes of electronic devices or depending upon the various capabilities or characteristics of different electronic devices.

When a new software or firmware upgrade is available, an alert can be triggered on the administrator's PC (transmitter 110 shown in FIGS. 1 and 2). The administrator can drag the upgrade alert to a folder which represents a particular grouping or subset of receivers associated with the distribution list 520 or the distribution list 530. The grouping or subset can include a single receiver or a plurality of the receivers 210, 250, 251, 252, 253, 254 (shown in FIGS. 1 and 2). The grouping or subset can also include all or substantially all of the plurality of the receivers 210, 250, 251, 252, 253, 254 (shown in FIGS. 1 and 2). Messaging software can automatically send messages, such as E-mail, including the software or firmware upgrade to each of the receivers 210, 250, 251, 252, 253, 254 (shown in FIGS. 1 and 2) or to a subset listing of receivers on a distribution list 520, 530. The digital signature applicator 120 (shown in FIG. 1) applies a digital signature to each of the messages before being sent to the receivers.

Upon receipt of messages acknowledging either receipt of the software or firmware upgrade or acknowledging successful completion of the received upgrade, the acknowledgment messages for a particular upgrade are compared to the distribution list 520, 530 associated with the upgrade. The receivers that have not successfully completed the upgrade can be displayed on the administrator 's computer (transmitter 110 of FIG. 1) so the administrator can address the receivers having problems with the software upgrade or firmware upgrade. Of course, there are other methods for inputting information to the administrator computer as to the destination of the software upgrade among a set of devices (receivers 210, 250, 251, 252, 253, 254 of FIGS. 1 and 2) of the software upgrade 412.

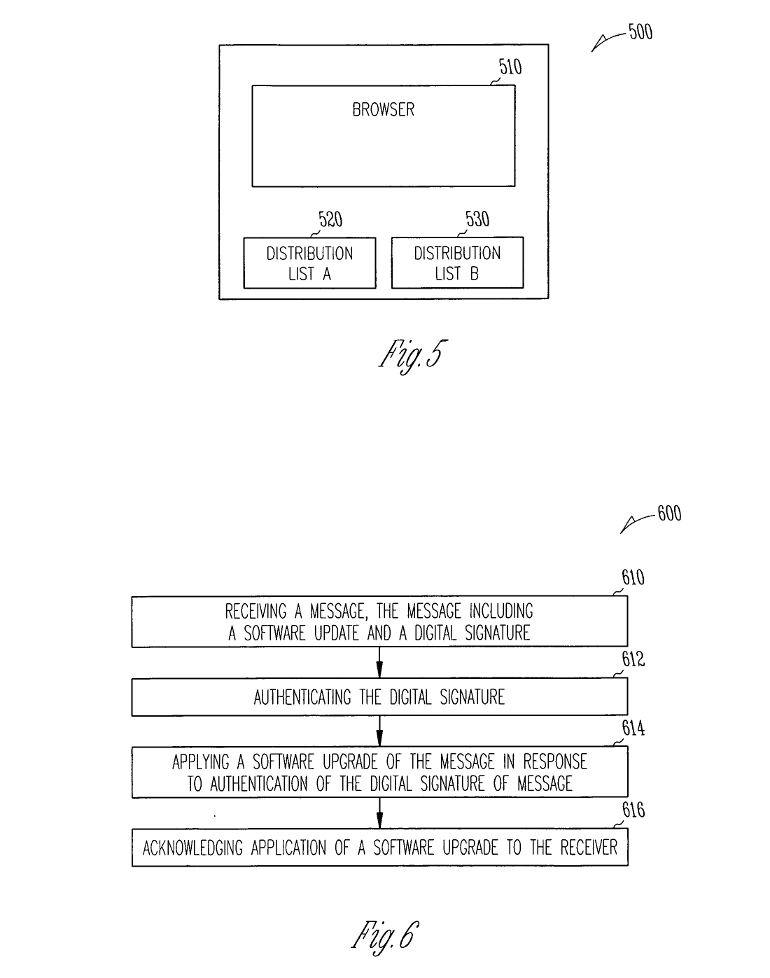

FIG. 6 is a flow diagram of a method for receiving a software upgrade 600, according to an embodiment of this invention. The method for receiving a software upgrade 600 includes receiving a message including a digital signature and a software upgrade from an administrator 610, authenticating the digital signature 612, and applying the software upgrade in response to authenticating the digital signature 614. Authenticating the digital signature 612 can include authenticating the transmitter 110 (shown in FIGS. 1 and 2) or can include authenticating the transmitter as well as authenticating that the message and upgrade was intended for the selected receiver in the set of receivers 210, 250, 251, 252, 253, 254 of FIG. 2. An acknowledger transmitter 216 acknowledges receipt of the message including the software upgrade 616. In some embodiments, the acknowledger transmitter 216 further indicates successful application of the software upgrade at the selected receiver of the plurality of receivers 210, 250, 251, 252, 253, 254 of FIG. 2.

Authenticating the digital signature 612 to include authenticating the transmitter as well as authenticating that the message and upgrade was intended for the selected receiver the set of receivers 210, 250, 251, 252, 253, 254 of FIG. 2 allows for providing updates by batch mode. In one embodiment, authenticating that the message and upgrade was intended for at least one selected receiver of the set of receivers 210, 250, 251, 252, 253, 254 of FIG. 2 is done by placing authenticating information specific to one or more of the receivers in the message. For example, the authenticating information placed with the message can be a model number of a receiver. The authenticating information can also include a software title and a version number. In this embodiment, a blanket message including the software upgrade and the authenticating information identifying one or more receivers 210, 250, 251, 252, 253, 254 of FIG. 2 is sent by the sender (administrator). A blanket message is defined as a message not specifically directed to selected receivers. For example, in one embodiment, an administrator can send a blanket message to all receivers associated with a network. In another embodiment, administrator may eliminate certain receivers known not to need a particular upgrade. The remaining receivers would be a subset that may need the software upgrade.

Upon receiving a blanket message, a receiver of the set of receivers 210, 250, 251, 252, 253, 254 of FIG. 2 compares the authenticating information related to the receiver in the message with the information stored regarding the device. If the authenticating information matches the information associated with the receiver, the receiver installs the upgrade. If the authenticating information fails to match the information associated with the receiver, the receiver does not install the upgrade. For example, an administrator can mail an upgrade for all receivers having version 2.1 of Digital Transmitter Driver 6. If the receiver has the particular version of the software and the message is authenticated as being from the administrator or sender and the software is installed.

Each of the transmitter and the receiver are an electronic device 700 that includes a computing system 702. The electronic device 700 that includes a computing system 702 can be any electronic device having an on-board processor and a storage device. An electronic device includes a computer, an imaging device, a digital sender, a multi-function peripheral, a digital network copier, or any other hardware device that includes a processor and a memory to operate a set of computer-readable instructions that are used to perform various functions.

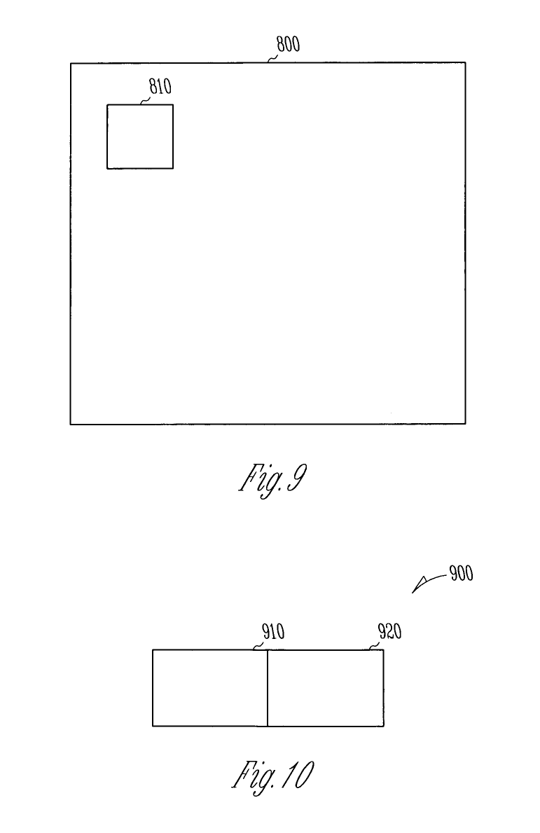

FIG. 10 is a flow diagram of a method for receiving a software upgrade 1000 according to an embodiment of this invention. The receivers 210, 250, 251, 252, 253, 254 (shown in FIG. 2) poll a network for an update 1010. Polling the network for an upgrade includes the receivers applying comparing selected criteria of the receiver to criteria associated with the upgrade. The selected criteria, in some embodiments, are upgrades within a range of versions. In other embodiments, the upgrade must be a particular version. In still other embodiments, the upgrades must be from selected sources or from a selected source. Upon finding an upgrade that matches a set of criteria, the receiver downloads the upgrade 1012. The receiver then requests confirmation of the upgrade 1014. The receiver sends a message to the transmitter. The transmitter confirms the upgrade 1016. Confirmation can be done on a manual basis or automatically. In the case of an automatic confirmation at the transmitter, the transmitter applies a set policy to the identified upgrade. The source of the upgrade is checked. Generally, the source of the upgrade is a company. One method of checking the source is to authenticate a digital signature associated with the upgrade. Another criterion that can be checked is the versions of the upgrade. Policy at the transmitter administrator may also include expanding the list of receivers to receive the upgrade. Once the upgrade is confirmed, the transmitter sends a message with a digital signature of the transmitter to at least the one receiver requesting the upgrade that approves the upgrade 1018. The receiver then authenticates the message approving the upgrade by authenticating the digital signature of the message and updates the software or firmware 1020. The software or firmware can be retrieved from a location where it was previously stored. In some embodiments, the location of the upgrade is noted and the upgrade is downloaded 1012 as part of upgrading the software 1020.

Turning to FIG. 2, in each of the embodiments discussed so far, messages are used to implement or provide an upgrade. In one embodiment, the message is an E-mail. The network 260 includes multiple receivers. Some of the receivers are behind a firewall, such as receiver 253 which is behind the firewall 270. E-mail updates from an administrator transmitter can get around a firewall without special settings or adjustments. In other words, the firewall 270 can be traversed via an E-mail that can include specific instructions on how to email back an automated response. This eases the upgrading process for the administrator.

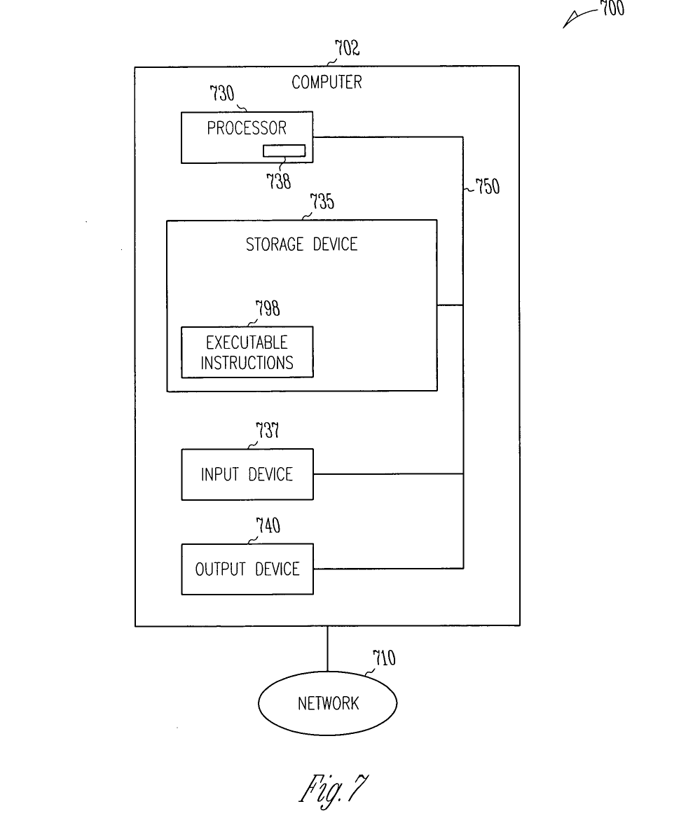

FIG. 7 is a schematic diagram of the electronic device 700. The electronic device 700 includes a computing system 702, according to an embodiment of this invention. The computer system 702 includes a processor 730 and a storage device 735. The storage device 735 includes executable instructions 798. The executable instructions 798 are stored within the storage device 735. The electronic device 700 can include an interface or connection to a network 710. The network 710 can correspond to network 260 (shown in FIG. 2). The computing device 702 is communicatively coupled to the network 710.

The processor 730 represents a central processing unit of any type of architecture, such as a CISC (Complex Instruction Set Computing), RISC (Reduced Instruction Set Computing), VLIW (Very Long Instruction Word), or hybrid architecture, although any appropriate processor may be used. The processor 730 executes instructions. The processor 730 also includes a control unit 738 that organizes data and program storage in memory and transfers data and other information in and out of the computing device 702 and to and from the network 710 and other devices attached to the network 710. The processor 730 receives input data from the input device 737 and the network 710, reads and stores code and data in the storage device 735, and presents data to an output device 740 and/or the network 710.

Although the computing device 702 is shown to contain only a single processor 730 and a single bus 750, the present invention applies equally to computing devices 702 that include multiple processors and multiple buses with some or all performing different functions in different ways.

The storage device 735 represents one or more mechanisms for storing data. For example, the storage device 735 may include read only memory (ROM), random access memory (RAM), magnetic disk storage media, optical storage media, flash memory devices, and/or other machine-readable media. In other embodiments, any appropriate type of storage device may be used. Although only one storage device 735 is shown, multiple storage devices and multiple types of storage devices may be present. In various embodiments, some or all of the controller 738, or other items shown as stored with the storage device 735 may be stored on the same or on different storage devices. Furthermore, although the computing device 702 is drawn to contain the storage device 735, it may be distributed across other computing devices, such as other computing devices attached to the network 710.

The controller 738 includes instructions capable of being executed on the processor 730 to carry out the functions of the present invention. In another embodiment, some or all of the functions of the present invention are carried out via hardware in lieu of a processor-based system.

The input device 737 may be a keyboard, mouse or other pointing device, trackball, touchpad, touch screen, keypad, microphone, voice recognition device, or any other appropriate mechanism for the user to input data to the electronic device 700. Although the input device 737 is represented as one box as shown in FIG. 7, it is to be understood that in another embodiment any the one box can represent a plurality of input devices.

The output device 740 is that part of the computing device 702 that communicates outputs to the user. In some embodiments, the output device 740 can also communicate outputs to other computing devices. The output device 740 may be a cathode-ray tube (CRT) based video display. But, in other embodiments the output device 740 may be replaced with a liquid crystal display (LCD) based or gas, plasma-based, flat-panel display. In another embodiment, the output device 740 may be a speaker. In still other embodiments, any appropriate output device may be used. Although one output device 740 is shown, in other embodiments, any number of output devices of different types or of the same type may be present. In one embodiment, the output device is part of the computing device 702, such as a flat panel display on an exterior housing of the computing device. In another embodiment, the output device is a separate, stand-alone device.

The bus 750 may represent one or more busses, e.g., PCI, ISA (Industry Standard Architecture), X-Bus, EISA (Extended Industry Standard Architecture), or any other appropriate bus and/or bridge (also called a bus controller).

The computing device 702 may be implemented using any suitable hardware and/or software, and includes many types of devices. For example, a computing device 702 includes personal computers, portable computers, laptop or notebook computers, PDAs (Personal Digital Assistants), pocket computers, main frame computers, telephones, pagers, printers, multi-function peripherals, digital sending devices, facsimile machines, imaging devices, appliances, and other devices. The other devices may include any device that uses firmware associated with the device. The hardware and software depicted in FIG. 7 may vary for specific applications and may include more or fewer elements than those depicted. For example, other peripheral devices such as audio or chip programming devices, such as EPROM (Erasable Programmable Read-Only Memory) programming devices may be used in addition to or in place of the hardware already depicted.

The network 710, such as network 260 (shown in FIG. 2), can be any suitable network and may support any appropriate protocol suitable for communication between the electronic device 700 and other devices attached to one another through the network. In one embodiment, the network 710, such as network 260, may support wireless communications. In another embodiment, the network 710, such as network 260, may support hard-wired communications, such as a telephone line or cable. In another embodiment, the network 710 may support the Ethernet IEEE (Institute of Electrical and Electronics Engineers) 802.3x speification. In another embodiment, the network 710 may be the Internet and may support IP(internet Protocol). In another embodiment, the network 710 may be a local area network (LAN) or a wide area network (WAN). In another embodiment, the network 710 may be an intranet. In another embodiment, the network 710 may be a GPRS (General Packet Radio Service) network. In another embodiment, the network 710 may be any appropriate cellular data network or cell-based radio network technology. In another embodiment, the network 710 may be a wireless network. In still another embodiment, the network 710 may be any suitable network or combination of networks. Although one network 710 is shown, in other embodiments any number of networks (of the same or different types) may be represented by the network element 710 shown in FIG. 7.

Aspects of an embodiment pertain to specific apparatus and method elements implementable on a computing device. In another embodiment, the invention may be implemented as a program product for use with an electronic device. The programs defining the functions of this embodiment may be delivered to an electronic device via a variety of signal-bearing media, which include, but are not limited to:

(1) Information permanently stored on a non-rewriteable storage medium, e.g., a read-only memory device attached to or within an electronic device, such as a CD-ROM readable by a CD-ROM drive;

(2) Alterable information stored on a rewriteable storage medium, e.g., a hard disk drive or diskette; or

(3) Information conveyed to an electronic device by a communications medium, such as through a computer or a telephone network, including wireless communications.

Such signal-bearing media, when carrying machine-readable instructions that direct the functions of the present invention, represent embodiments of the present invention.

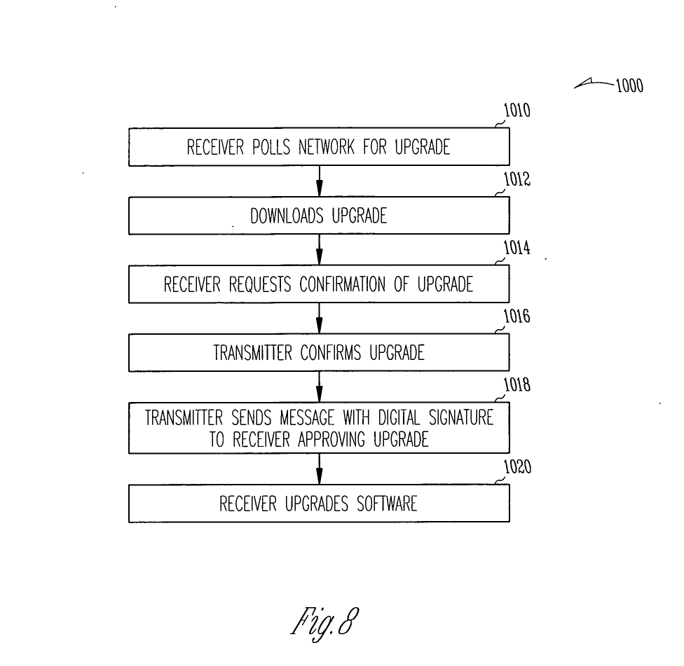

FIG. 8 is a block diagram of a computer readable medium 800 that includes an instruction set 810, thereon. The instruction set 810 can be any set of instructions including a computer program. The computer readable medium 800 can be any computer-readable medium including a storage device or a signal-bearing medium. A computer-usable storage medium having a computer program thereon causes a suitably configured information handling system, such as computing device 702 to execute the instructions thereon, such as transport messages between a transmitter device 110 and a receiver 210 (shown in FIGS. 1 and 2) as discussed herein.

A computer program product for use with a computer system associated with a network of devices, the computer program product comprising a computer usable medium having a set of instructions executable by a suitably programmed information handling system embodied in the computer usable medium for causing the computer system to apply a digital signature to a message including a software upgrade, transmit the message including the software upgrade to a destination, upgrade a device at the destination with the software upgrade of the message in response to authentication of the digital signature. The computer usable medium further causes the computer system to identify the transmitter of the message with the digital signature, and identify the destination of the message with the digital signature. The computer usable medium further causes the computer system to send an acknowledgment in response to upgrading the device at the destination.

A computer program product includes a computer usable medium having a set of instructions executable by a suitably programmed information handling system embodied in the computer usable medium causes the computer system to distribute a software upgrade to a network of devices. The computer program product includes a computer usable medium having a set of instructions executable by a suitably programmed information handling system embodied in the computer usable medium to cause the computer system to receive a software upgrade into an administrator, receive an input from a user of the administrator user as to the destination of the software upgrade among a set of devices on the network, and transmit a message including the software upgrade to the destination of the software upgrade. The computer program product for use with a computer system associated with a imaging device, wherein the computer usable medium further causes the computer system to apply a digital signature to the message. The computer usable medium further causes the computer system to apply a digital signature to the message. In some embodiments, the digital signature identifies the administrator. In another embodiment, the computer usable medium further causes the computer system to apply a digital signature to the message, the digital signature identifying the administrator and identifying the destination of the software upgrade. In another embodiment, the computer usable medium further causes the computer system to store a list of the plurality of devices to which the message including a software upgrade was sent. The computer program product for use with a computer system associated with a imaging device, wherein the computer usable medium further causes the computer system to: receive an acknowledgement from a subset of the plurality of devices to which the message was sent, and store a list of the devices from which an acknowledgement was received. The computer program product for use with a computer system associated with an imaging device, wherein the computer usable medium further causes the computer system to compare the list of the plurality of devices to which the message including a software upgrade was sent to the list of the devices from which an acknowledgement was received. The computer usable medium further causes the computer system to upgrade a device associated with the destination upon an authentication of the digital signature.

FIG. 9 is a schematic of a data structure 900 associated with a message according to an embodiment of the invention. A transmitted data structure 900 includes a software upgrade 910, and a digital signature 920. The digital signature 920 includes a portion that identifies a transmitter of the transmitted data structure. In some embodiments, the digital signature 920 includes a portion that identifies a transmitter of the transmitted data structure, and a portion that identifies a device intended to receive the transmitted data structure. In some embodiments of the invention, the data structure 900 is part of a message. In still other embodiments, the data structure 900 is part of an E-mail.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

1. A transmitter comprising:
a software upgrade receiver that receives a software upgrade;
a storage device for holding information related to a set of devices;
an input device for selecting a subset of the set of devices based on the information related to the set of devices, the subset having one or more of the devices of the set of devices;
a digital signature applicator for applying a digital signature to the message; and
a transmitter that transmits a message including a software upgrade for the selected subset of devices.

2. The transmitter of claim 1 wherein the digital signature applicator applies a digital signature associated with the transmitter of the message.

3. The transmitter of claim 1 wherein the digital signature applicator applies a first digital signature related to the transmitter to the message and applies a second digital signature related to the intended receiver of the message.

4. The transmitter of claim 1 wherein the digital signature applicator applies a digital signature related to the transmitter and related to the intended receiver of the message.

5. The transmitter of claim 1 further comprising an interface to a network of computing devices.

6. The transmitter of claim 1 wherein the message is an E-mail.

7. The transmitter of claim 1 further comprising a list of the selected subset of devices to which a message is sent.

8. The transmitter of claim 7 further comprising a list of the devices of the selected subset of devices that have returned an acknowledgement to the transmitter.

9. The transmitter of claim 8 further comprising a comparator that compares the list of the selected subset of devices to which a message is sent to the list of devices of the selected subset of devices that have returned an acknowledgement to the transmitter.

10. The transmitter of claim 8 wherein the acknowledgment is related to installation of the software upgrade on one device of the selected subset of devices to which the message was sent.

11. The transmitter of claim 1 wherein the transmitter and the set of devices are connected to a network.

12. The transmitter of claim 1 wherein the transmitter is connected to a network.

13. The transmitter of claim 1 wherein the software upgrade is a firmware upgrade related to the selected subset of devices.

14. A method for distributing software upgrade comprising:
receiving a software upgrade into an administrator;
receiving input from a user of the administrator user as to the destination of the software upgrade among a set of devices of the software upgrade;
applying a digital signature to the message; and
transmitting a message including the software upgrade to the destination of the software upgrade.

15. The method of claim 14 further comprising transmitting a time stamp with the message.

16. The method of claim 14 further comprising applying a digital signature to the message, the digital signature identifying the administrator.

17. The method of claim 14 further comprising applying a digital signature to the message, the digital signature identifying the administrator and identifying the destination of the software upgrade.

18. The method of claim 17 wherein identifying the destination of the software upgrade includes identifying a plurality of devices to be upgraded.

19. The method of claim 18 further comprising storing a list of the plurality of devices to which the message including a software upgrade was sent.

20. The method of claim 19 further comprising:
receiving an acknowledgement from a subset of the plurality of devices to which the message was sent; and
storing a list of the devices from which an acknowledgement was received.

21. The method of claim 20 further comprising comparing the list of the plurality of devices to which the message including a software upgrade was sent to the list of the devices from which an acknowledgement was received.

22. The method of claim 14 further comprising applying the software upgrade to at least one device associated with the destination of the message.

23. The method of claim 15 further comprising upgrading a device associated with the destination upon an authentication of the digital signature.

24. A method for distributing software upgrade comprising:
applying a digital signature to a message including a software upgrade;
transmitting the message including the software upgrade to a destination; and
upgrading a device at the destination with the software upgrade of the message in response to authentication of the digital signature.

25. The method of claim 24 wherein applying a digital signature to the message includes identifying the transmitter of the message with the digital signature.

26. The method of claim 24 wherein applying a digital signature to the message includes:
identifying the transmitter of the message with the digital signature; and
identifying the destination of the message with the digital signature.

27. The method of claim 24 further comprising sending an acknowledgment in response to upgrading the device at the destination.

28. A receiver comprising:
a message receiver that receives a message, the message including
a software upgrade; and
a digital signature;
an authenticator for authenticating the digital signature; and
a software upgrade applicator for applying the software upgrade of the message in response to authentication of the digital signature of message.

29. The receiver of claim 28 wherein the authenticator authenticates the digital signature in response to associating the digital signature with a selected sender.

30. The receiver of claim 29 wherein the digital signature further includes a portion identifying the receiver, and wherein the authenticator authenticates the digital signature in response to determining that the message was directed to the receiver.

31. The receiver of claim 28 further comprising an acknowledger for acknowledging application of a software upgrade to the receiver.

32. The receiver of claim 28 further comprising a storage device for holding information related to a set of devices.

33. The receiver of claim 28 wherein the message further comprises a list of identifiers for devices designated for receipt of the software upgrade and wherein the device further comprises a comparator for comparing a unique identifier associated with the receiver to the list of identifiers.

34. The receiver of claim 33 wherein the identifiers are serial numbers of the devices.

35. The receiver of claim 28 further comprising an interface to a network of computing devices.

36. The receiver of claim 28 wherein the message is an E-mail.

37. A system comprising:
a transmitter for receiving a software upgrade and transmitting a message that includes the software upgrade and a digital signature; and
a receiver that receives the message, authenticates the digital signature and installs the software upgrade in response to authentication of the digital signature.

38. The system of claim 37 wherein the digital signature includes information regarding the transmitter of the message.

39. The system of claim 38 wherein the digital signature includes information regarding the receiver of the message.

40. The system of claim 37 wherein the transmitter further comprises a list of a plurality of devices to which the transmitter can transmit a message including the software upgrade and wherein the transmitter includes a selector for designating a subset of devices of the plurality of devices to which a message having the software upgrade is sent.

41. The system of claim 40 wherein the selector designates a subset of the plurality of devices based on serial numbers of the plurality of devices.

42. The system of claim 40 wherein the selector designates a subset of the plurality of devices based on model numbers of the plurality of devices.

43. The system of claim 40 wherein the selector designates a subset of the plurality of devices based on model numbers of the plurality of devices and based on version numbers of the software associated with the plurality of devices.

44. The system of claim 37 wherein the receiver further comprises an acknowledger for acknowledging application of a software upgrade to the receiver.

45. The system of claim 44 wherein the transmitter further includes a storage apparatus, the transmitter storing a list of the subset of the plurality of devices to which the message including the software upgrade was sent.

46. A transmitted data structure comprising:
a software upgrade; and
a digital signature.

47. The transmitted data structure of claim 46 wherein the digital signature includes a portion that identifies a transmitter of the transmitted data structure.

48. The transmitted data structure of claim 46 wherein the digital signature includes:
a portion that identifies a transmitter of the transmitted data structure; and
a portion that identifies a device intended to receive the transmitted data structure.

49. A computer program product for use with a computer system associated with a network of devices, the computer program product comprising a computer usable medium having a set of instructions executable by a suitably programmed information handling system embodied in the computer usable medium for causing the computer system to:
apply a digital signature to a message including a software upgrade;
transmit the message including the software upgrade to a destination; and
upgrade a device at the destination with the software upgrade of the message in response to authentication of the digital signature.

50. The computer program product for use with a computer system associated with a printing device of claim 49, wherein the computer usable medium further causes the computer system to
identify the transmitter of the message with the digital signature; and
identify the destination of the message with the digital signature.

51. The computer program product for use with a computer system associated with a printing device of claim 49, wherein the computer usable medium further causes the computer system to send an acknowledgment in response to upgrading the device at the destination.

52. A computer program product for use with a computer system for distributing a software upgrade to a network of devices, the computer program product comprising a computer usable medium having a set of instructions executable by a suitably programmed information handling system embodied in the computer usable medium for causing the computer system to:
receive a software upgrade into an administrator;
receive an input from a user of the administrator as to the destination of the software upgrade among a set of devices on the network; and
transmit a message including the software upgrade to the destination of the software upgrade.

53. The computer program product for use with a computer system for distributing a software upgrade of claim 52, wherein the computer usable medium further causes the computer system to apply a digital signature to the message.

54. The computer program product for use with a computer system for distributing a software upgrade of claim 52, wherein the computer usable medium further causes the computer system to apply a digital signature to the message, the digital signature identifying the administrator.

55. The computer program product for use with a computer system for distributing a software upgrade of claim 52, wherein the computer usable medium further causes the computer system to apply a digital signature to the message, the digital signature identifying the administrator and identifying the destination of the software upgrade.

56. The computer program product for use with a computer system for distributing a software upgrade of claim 52, wherein the computer usable medium further causes the computer system to store a list of the plurality of devices to which the message including a software upgrade was sent.

57. The computer program product for use with a computer system for distributing a software upgrade of claim 56, wherein the computer usable medium further causes the computer system to:
receive an acknowledgement from a subset of the plurality of devices to which the message was sent; and
store a list of the devices from which an acknowledgement was received.

58. The computer program product for use with a computer system for distributing a software upgrade of claim 57, wherein the computer usable medium further causes the computer system to compare the list of the plurality of devices to which the message including a software upgrade was sent to the list of the devices from which an acknowledgement was received.

59. The computer program product for use with a computer system for distributing a software upgrade of claim 52, wherein the computer usable medium further causes the computer system to upgrade a device associated with the destination upon an authentication of the digital signature.

60. An apparatus for distributing a software upgrade comprising:
means for applying a digital signature to a message including a software upgrade;
means for transmitting the message including the software upgrade to a destination; and
means for upgrading a device at the destination with the software upgrade of the message in response to authentication of the digital signature.

61. The apparatus of claim 60 further comprising means for sending an acknowledgment in response to upgrading the device at the destination.

62. A method for distributing software comprising:
polling a network for a software upgrade;
receiving a message confirming the software upgrade; and
installing the software upgrade in response to receiving the message confirming the software upgrade, wherein receiving the message confirming the software upgrade includes authenticating a digital signature.

63. The method for distributing software of claim 62 further comprising transmitting a message seeking confirmation of the software upgrade.

64. The method for distributing software of claim 62 further comprising:
receiving a time stamp; and
comparing the time stamp to a current time.
